(19) United States
(12) Patent Application Publication
(10) Pub. No.: US 2014/0136168 A1
(43) Pub. Date: May 15, 2014

(54) DRILL BIT SIMULATION AND OPTIMIZATION

(71) Applicants: Reed Spencer, Spring, TX (US); Jonathan M. Hanson, Salt Lake City, UT (US)

(72) Inventors: Reed Spencer, Spring, TX (US); Jonathan M. Hanson, Salt Lake City, UT (US)

(73) Assignee: BAKER HUGHES INCORPORATED, Houston, TX (US)

(21) Appl. No.: 14/077,748

(22) Filed: Nov. 12, 2013

Related U.S. Application Data
(60) Provisional application No. 61/725,638, filed on Nov. 13, 2012.

(51) Int. Cl. G06F 17/50

(52) U.S. Cl. CPC G06F 17/5009
USPC 703/2

(57) ABSTRACT

A method of predicting behavior of a drill bit includes: generating, by a processor, a representation of at least one component of the drill bit, the representation representing a three-dimensional object as a combination of at least two two-dimensional polygons; representing a borehole formed in an earth formation during a drilling operation by generating a mathematical representation of a borehole surface defined by a plurality of nodes; simulating operation of the drill bit within the borehole with the application of one or both of axial load and a side load; determining whether the three-dimensional object is in contact with the borehole surface by determining if one of the nodes is within both of the two-dimensional polygons during the simulation; and estimating an amount of lateral motion of the drill bit during the simulation.

### CROSS REFERENCE TO RELATED APPLICATION

This application is a nonprovisional of U.S. patent application Ser. No. 61/725,638, filed Nov. 13, 2012, under 35 U.S.C. §119(e), which is incorporated herein by reference in its entirety.

### BACKGROUND OF THE INVENTION

Boreholes in earth formations for the purpose of producing fluids from earth formations such as for use in the production of oil or other hydrocarbons, or for the purpose of depositing fluids into earth formations, are usually drilled with a drill string that includes a tubular member having a drilling assembly (also referred to as the bottom hole assembly or “BHA”) that includes a drill bit attached to the bottom end thereof. The drill bit is rotated by a motor included in the BHA so as to disintegrate the earth formations to drill the borehole. The drill bit can have various components such as blades, cutters and other body components. In order to evaluate brill bit behavior during drilling, models of the drill bit can be generated and the drill bit's operation can be tested through computer simulations.

As in most endeavors, in the drilling industry it is desirable to drill in an efficient manner. It is known that a drill bit can more efficiently penetrate into a formation when it rotates about a fixed rotational axis. When the bit rotates about a fixed rotational axis it is said to exhibit synchronous rotation. It is also known that certain physical phenomena can cause the rotation of the bit to vary from a synchronous rotation. Types of vibration include, for example, stick-slip, bit bounce and whirl. “Whirl” is used to describe the situation where the bit rotates about a moving rotational axis. One particular type of whirl is referred to as backward whirl can exist when one or more of the bit blades is moving in a direction opposite of motion direction of rotation of the bit.

While attempts are usually made to avoid effects such as whirl or other off-axis rotations of bit, in some cases such rotation is actually encouraged. For instance, in directional drilling where the drill string is purposely caused to follow a curved trajectory. Directional drilling involves placing a bent adjustable kick off (AKO) sub between the drill bit and the motor. In other cases, an AKO may be omitted and a side load applied to the drill string/bit to cause the bit to travel laterally as it descends downward. In directional drilling (with our without an AKO sub), the ability control the direction that a bit travels is referred to as “tool face control.” The more controllable a particular bit is, the better its tool face control.

One type of rotary drill bit is the fixed-cutter bit, often referred to as a “drag” bit. These bits generally include an array of cutting elements coupled to a face region (blade) of the bit body. The bit typically includes several blades distributed generally around a central axis of the bit. A hard, abrasive material, such as mutually bonded particles of polycrystalline diamond, may be provided on a substantially circular end surface of each cutting element to provide a cutting surface. Such cutting elements are often referred to as “polycrystalline diamond compact” (PDC) cutters. In operation, a fixed-cutter drill bit is placed in a borehole such that the cutting elements are in contact with the earth formation to be drilled. As the drill bit is rotated, the cutting elements scrape across and shear away the surface of the underlying formation.

### BRIEF SUMMARY OF THE INVENTION

In one embodiment, a method of method of predicting behavior of a drill bit disclosed. The method of this embodiment includes: generating, by a processor, a representation of at least one component of the drill bit, the representation representing a three-dimensional object; representing a borehole formed in an earth formation during a drilling operation by generating a mathematical representation of a borehole surface defined by a plurality of nodes; simulating operation of the drill bit within the borehole with the application of an axial load and a side load; determining whether the three-dimensional object is in contact with the borehole surface by determining if one of the nodes is within both of the two-dimensional polygons during the simulation; and estimating an amount of lateral motion of the drill bit during the simulation.

According to another embodiment a method of selecting a drill bit for directional drilling is disclosed. The method of this embodiment includes: generating, by a processor, a representation of at least one component of the drill bit, the representation representing a three-dimensional object as a combination of at least two two-dimensional polygons; representing a borehole formed in an earth formation during a drilling operation by generating a mathematical representation of a borehole surface defined by a plurality of nodes; simulating operation of the drill bit within the borehole with the application of a weight on bit (WOB), the simulation including causing the drill bit to initially rotate about a drill bit axis that is coaxial with an axis of the borehole, the simulation including increasing one of the WOB and a rate of penetration (ROP) of the drill bit over time; determining the displacement of the drill bit axis from the axis of the borehole over time; and determining the WOB or ROP that results in the drill bit stabilizing in the borehole.

According to another embodiment, a method of selecting between one of two drill bits for use in directional drilling includes: generating, by a processor, a representation of at least one component of a first and a second drill bit, the representation representing a three-dimensional object as a combination of at least two two-dimensional polygons; representing a borehole formed in an earth formation during a drilling operation by generating a mathematical representation of a borehole surface defined by a plurality of nodes; simulating operation of the first drill bit and the second drill within the borehole with the application of an axial load, the simulation including causing the first and second drill bits to initially rotate about a drill bit axis, the simulation including increasing the rate of penetration (ROP) of the first and second drill bit over time; determining the displacement of the first drill bit and the second drill bit axis from the axis of the borehole over time; determining the ROP that results in the first and second drill bits stabilizing in the borehole; and selecting from the first and second drill bit for direction drilling the one stabilizes at the lower ROP.

According to another embodiment, a method of selecting between one of two drill bits for use in directional drilling includes: generating, by a processor, a representation of at least one component of a first and a second drill bit, the representation representing a three-dimensional object as a combination of at least two two-dimensional polygons; representing a borehole formed in an earth formation during a drilling operation by generating a mathematical representation of a borehole surface defined by a plurality of nodes; simulating operation of the first drill bit and the second drill within the borehole with the application of an axial load, the simulation including causing the first and second drill bits to initially rotate about a drill bit axis, the simulation including increasing the side load of the first and second drill bit over time; determining the displacement of the first drill bit and the second drill bit axis from the axis of the borehole over time; determining the side load that results in the first and second drill bits stabilizing in the borehole; and selecting from the first and second drill bit for direction drilling the one stabilizes at the lower side load.

According to another embodiment, a method of selecting between one of two drill bits for use in directional drilling includes: generating, by a processor, a representation of at least one component of a first and a second drill bit; representing a borehole formed in an earth formation during a drilling operation by generating a mathematical representation of a borehole surface defined by a plurality of nodes; simulating operation of the first drill bit and the second drill within the borehole with the application of an axial load, the simulation including causing the first and second drill bits to initially rotate about a drill bit axis, the simulation including increasing the side load of the first and second drill bit over time; determining the side load that results in the first and second drill bits stabilizing in the borehole; and selecting from the first and second drill bit for direction drilling the one stabilizes at the lower side load.

According to another embodiment, a method predicting behavior of a drill bit includes: generating, by a processor, a representation of at least one component of the drill bit, the representation representing a three-dimensional object as a combination of at least two two-dimensional polygons; representing a borehole formed in an earth formation during a drilling operation by generating a mathematical representation of a borehole surface defined by a plurality of nodes; simulating operation of the drill bit within the borehole with the application of an axial load and a side load, wherein the side load and the rate of penetration (ROP) are increased per unit time during the simulation; determining whether the three-dimensional object is in contact with the borehole surface by determining if one of the nodes is within both of the two-dimensional polygons during the simulation; determining the displacement of the drill bit axis from the axis of the borehole over time; and determining the ROP that results in the drill bit stabilizing in the borehole.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 is an exemplary embodiment of a drilling and/or geosteering system including a drill string disposed in a borehole in an earth formation;

FIG. 2 is a perspective views of an exemplary embodiment of a drill bit of the drilling system of FIG. 1;

FIG. 3 is a flow chart representing an embodiment of a method of predicting and/or simulating behavior of a drilling assembly using a model of the drilling assembly;

FIG. 4 is an illustration of a portion of an exemplary geometrical model of a fixed cutter drill bit; and

FIG. 5 is an illustration of a portion of an exemplary geometrical model of a roller cone drill bit;

FIG. 6 is an illustration of an exemplary two-dimensional polygon representing a three-dimensional roller cone shell object of the model of FIG. 5;

FIGS. 7A-7B are illustrations of an exemplary three-dimensional object representing a cutter blade of the fixed cutter drill bit of FIG. 4;

FIGS. 8A-8B are illustrations of an exemplary pair of two-dimensional polygons representing the cutter blade object of FIG. 7;

FIGS. 9A-9B are illustrations of an exemplary pair of two-dimensional polygons representing a three-dimensional gage pad object of the model of FIG. 4;

FIG. 10A-10B are illustrations of an exemplary three-dimensional object representing gage cutters of a fixed cutter drill bit;

FIG. 11 shows a conceptual view of a system where a side load is applied to a drill bit;

FIG. 12 illustrates various bit operational characteristics that may be experienced during a simulation;

FIG. 13 is a flow chart showing method according to one embodiment; and

FIG. 14 shows a graph of bit position overtime with increasing side load.

### DETAILED DESCRIPTION OF THE INVENTION

Disclosed are exemplary techniques for estimating or predicting the behavior of a drilling assembly, which utilize one or more mathematical models of a drilling assembly that simulates the forces and loads experienced by the drill string assembly in a downhole environment, as well as interactions between the drilling assembly with the borehole environment (e.g., the borehole wall, formation materials and/or borehole fluid). In one embodiment, methods and associated software are provided for generating a mathematical model of the drilling assembly, which includes a model of rock removal behavior of individual bit components, including cutters, gage pads and other components in contact with the formation during drilling. By simulating the gage pads, the effect of application of a side load onto the drill bit can be simulated and analyzed.

In one embodiment, building the model includes generating a three-dimensional (3D) geometric model of each component of a drill bit that contacts the borehole wall while drilling. Each component of the 3D model may also be represented by one or more two-dimensional (2D) polygons. In one embodiment, an earth formation is modeled by generating a borehole surface that includes a plurality of nodes. Surfaces of the drilling assembly (e.g., the drill bit) that contact the formation may be modeled based on position information of each node relative to each component model. The model may also include information regarding the interaction between each individual component and the formation based on calibration data generated by testing of each component. In addition, the model may include a model of both rock displaced by the 3D object(s) and sliding wear to generate a complete model of all rock removal by the drill bit. It shall be understood that the above described rock removal can particularly involve rock removed by gage pads.

The models described above can be used in several different manners. For instance, for a particular bit the effect of a side load on the bit can be simulated. This may provide information that allows for a driller or person to select a particular bit to achieve a certain lateral migration based on an estimated side load, for example. Such simulations have not previously been run because an effective model of a drill bit that can include interactions of the sides of the bit (e.g., the gage pads) has not previously been available.

In another embodiment, the stability of a bit under a side load can be determined. Again, the simulation can include applying a side load but in this case the side load varies. In this embodiment, a side load at which a particular bit stabilizes can be determined by examining an excursion of a rotational point of the bit from a center point (e.g., a center point of the borehole). The side load that results in a semi-constant excursion denotes when stability is achieved.

The stability of a bit, similar to above, can be determined by observing displacements of central location on the bit from a rotational axis of the bit. We have discovered that bits that stabilize at lower rates of penetration (ROP) without application of a side load typically exhibit better tool face control. Thus, in one embodiment, the teachings herein can be utilized to compare the stability of two bits to determine which will exhibit better tool face control. In one embodiment, one of the bits is a “standard” against which other bits are measured. In addition, to the extent that the bit is not stable, models can be used to determine/predict an amount by which a particular bit may tend to enlarge a hole due to its instability.

As discussed below, the body of the drill bit (including the gage pads) can be part of the rock removal model. Applying a side load to an actual bit can be used to calibrate the bit body rock removal.

Given the above description various simulations that can run, the skilled artisan that the calibrated model of a drill bit can be used in a design/optimization of the directional control properties of a particular bit.

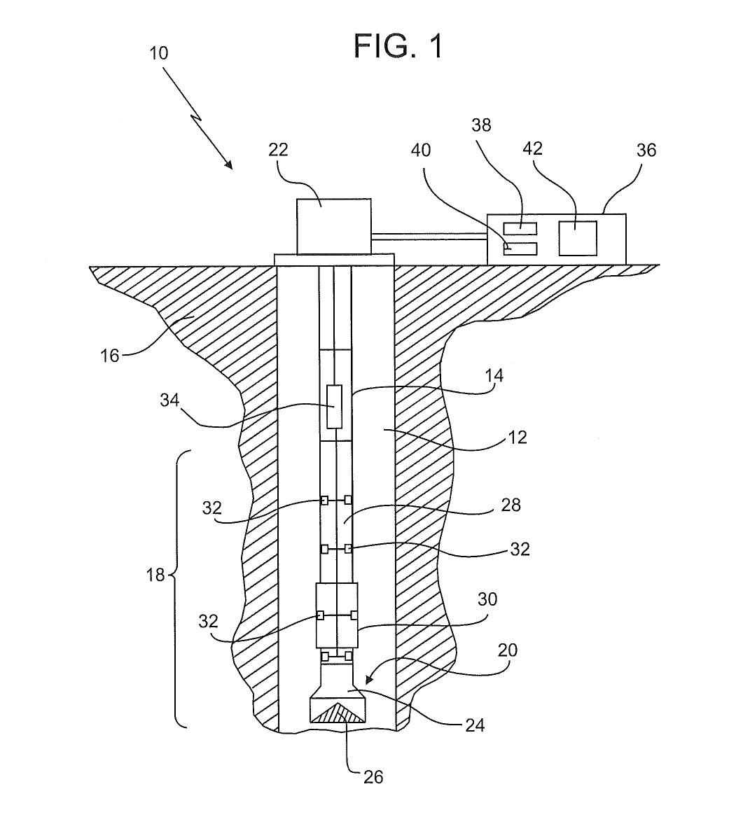

Referring to FIG. 1, an exemplary embodiment of a downhole drilling and/or geosteering system 10 disposed in a borehole 12 is shown. A drill string 14 is disposed in the borehole 12, which penetrates at least one earth formation 16. Although the borehole 12 is shown in FIG. 1 to be of constant diameter, the borehole is not so limited. For example, the borehole 12 may be of varying diameter and/or direction (e.g., azimuth and inclination). The drill string 14 is made from, for example, a pipe or multiple pipe sections. A drilling assembly 18, which may be configured as a bottomhole assembly (BHA), includes a drill bit 20 that is attached to the bottom end of the drill string 14 via various drilling assembly components. The drilling assembly 18 is configured to be conveyed into the borehole 12 from a drilling rig 22. Exemplary drilling assembly components include a drill bit body 24 operably connected to cutters 26, a drilling motor 28 (e.g., a mud motor), and a stabilizer or reamer 30. In the embodiment shown in FIG. 1, the drill bit is a roller cone bit having three cones, each cone including a cone shell and cutters (e.g., inserts or other cutting elements) that interact with the formation 16 during drilling.

In one embodiment, the drill bit 20 and/or drilling assembly 18 includes one or more sensors 32 and related circuitry for estimating one or more parameters relating to the drilling assembly 18. For example, a distributed sensor system (DSS) is disposed at the drilling assembly 18 and includes a plurality of sensors 32. The sensors 40 perform measurements associated with static parameters and/or the dynamic motion of the drilling assembly 18 and/or the drill string 14, and may also be configured to measure environmental parameters such as temperature and pressure. Non-limiting example of measurements performed by the sensors include accelerations, velocities, distances, angles, forces, moments, and pressures. In one embodiment, the sensors 40 are coupled to a downhole electronics unit 34, which may receive data from the sensors 40 and transmit the data to a processing system.

A processing unit 36 is shown in FIG. 1 that may be utilized to generate, receive and/or process data relating to formation of a model of the drilling assembly 18 and/or the drill bit 20. The processing unit 36 may receive input data that is used to generate various models of the drilling assembly, including models that simulate performance of the drilling assembly during a drilling and/or steering operation.

In one embodiment, the processing unit 36 is connected in operable communication with the drilling assembly 18 and may be located, for example, at a surface location, a subsea location and/or a surface location on a marine well platform or a marine craft. The processing unit 36 may also be incorporated with the drill string 14 or the drilling assembly 18, or otherwise disposed downhole as desired. The processing unit 36 may be configured to perform functions such as controlling the drilling assembly 18, transmitting and receiving data, processing measurement data, monitoring the drilling assembly 18, and performing simulations of the drilling assembly 18 using mathematical models. The processing unit 36, in one embodiment, includes a processor 38, a data storage device (or a computer-readable medium) 40 for storing, data, models and/or computer programs or software 42. Although the processing unit is described as in communication with downhole components, it may also be configured as a stand-alone unit and provide processing for measurement data and/or simulation data without direct communication with a downhole system. The processing unit may be configured as a single processor or multiple processors, such as a network, cluster or cloud of computers.

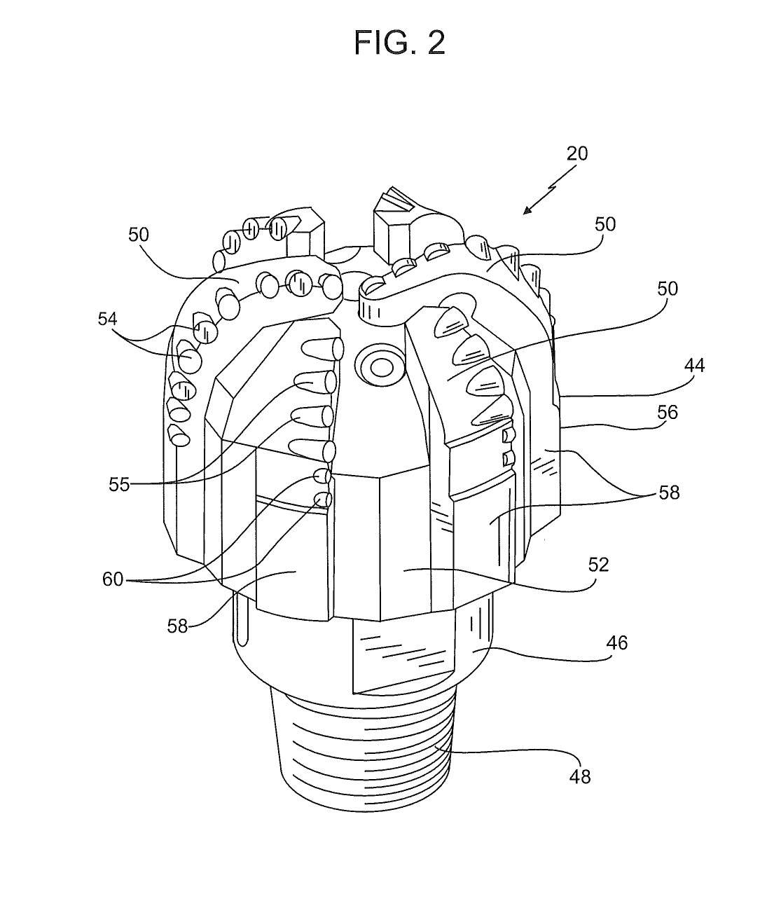

Although the drilling assembly of FIG. 1 is shown as including a roller cone bit, it is not so limited. For example, FIG. 2 shows an embodiment of an earth-boring rotary drill bit 20 configured as a fixed cutter bit (e.g., a PDC bit). The drill bit 20 includes a crown 44 and the bit body 24. The bit body 24 may include various components, such as a blank 46 connected to the crown 44, and a connection mechanism such as a threaded connection 48 for operably connecting the drill bit 20 to the drillstring or other components such as the mud motor 28 or reamer 30. The crown 44 includes wings or blades 50, which are separated by external channels or conduits also known as junk slots 52. A plurality of cutters 54 (e.g., PDC cutters) are disposed on the blades 50. Each cutter 54 may also include a cutter body 55 (e.g., the non-sharp cylindrical portion of the cutter), that may also interacts with the formation by, for example, rubbing against the borehole wall and/or material that has been cut or crushed due to the cutters 54. The bit body 24 also includes a bit gage 56. The bit gage includes gage pads 58, each of which is longitudinally adjacent to a respective blade 50. Gage trimmers 60 may be positioned within pockets located immediately adjacent and above gage pads 58. Further examples of components include other components that rub or contact the borehole wall or formation material in general, such as Tracblocks, ovoids, wear knots and others.

The embodiment shown in FIG. 2 is a fixed cutter bit such as polycrystalline diamond compact (PDC) bit. However, the drill bit 20 is not limited to the embodiments described herein, and may be any type or earth boring drill bit, such as a rotary drag bit, a roller cone bit, an impregnated bit, a hybrid bit and others.

Drilling assembly models may be generated to represent a drill bit and/or other parts of a drilling assembly, such as drill bits 20. The models are utilized to represent the geometry of the drill bit and simulate or predict the drill bit's interaction with the formation during drilling, including the forces exerted on individual components of the drill bit that contact the formation. The models may also include estimations or predictions of the amount of formation material or rock that is removed by the drilling assembly components. The term “rock” is used herein to denote various types of mineral and other solid materials found in an earth formation, and is not meant to exclude any formation materials found or removed during a drilling operation. Formation materials may include material that has not previously been contacted (e.g., virgin rock) and materials modified by the drilling action (e.g., cuttings, particles, crushed rock). The models include development of mathematical and numerical techniques to better understand the influence on drill bit performance of bit body rubbing or other contact between drilling components and the formation. The models are not limited to describing dill bits, but can also include various components such as the drill string, reamers, stabilizers, motor housing,

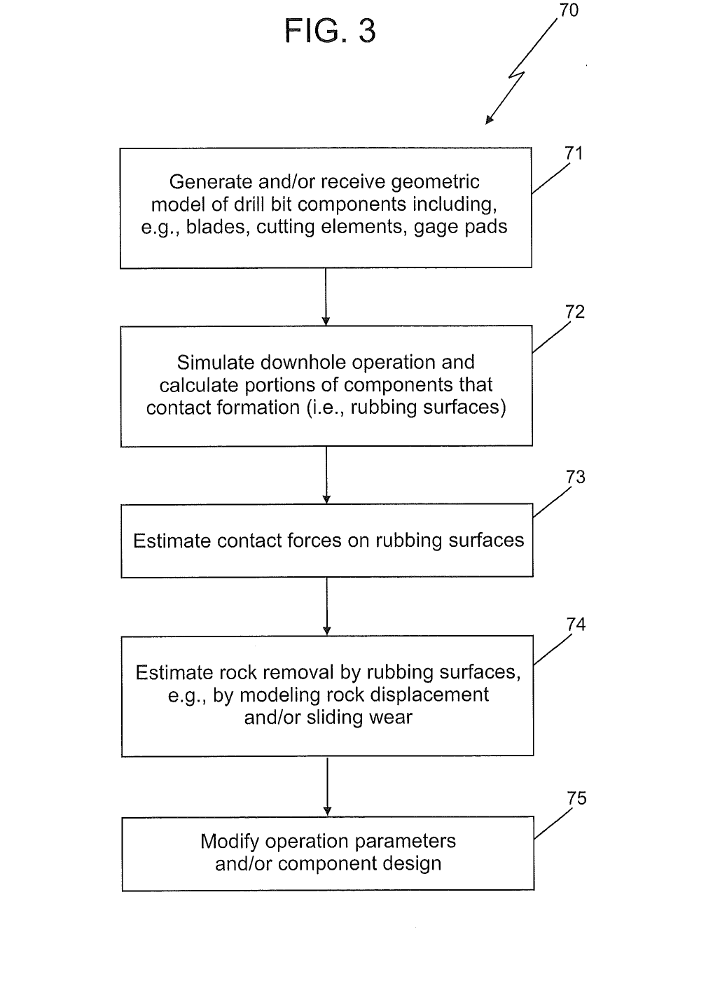

Referring to FIG. 3, a method 70 of predicting drill bit behavior is described. The method may be executed by a computer processing system (e.g., the processing unit 36) via programs or software for generating a drill bit model, such as a performance and/or rock removal, which may be used to investigate or predict the performance and behavior of the bit under selected downhole and drilling conditions. The method 70 includes one or more stages 71-74. In one embodiment, the method 70 includes the execution of all of stages 71-74 in the order described. However, certain stages may be omitted, stages may be added, or the order of the stages changed.

The method 70 may be performed via a single processor or multiple processors. For example, the method may be used with multiple processors, e.g., on a single machine with several processors, to run several simulations at a time. The method may also be used to preform one or more simulations via multiple processors such as a network, cluster or clouds. A single simulation may be performed in parallel on several processors or several simulations may be run simultaneously (on a single or multiple processors).

In the first stage 71, a geometric model of the drilling bit is received and/or generated. The geometric model includes three dimensional (3D) geometric data (e.g., size and shape) describing the drilling assembly. Representations may be generated or any of various components of the drill bit that could potentially come into contact with the formation during drilling. Examples of drill bit components include crowns, blades, gages, gage pads, cutters, grind flats on gage cutters, and roller cone shells. Other components that may be individually modeled include gage trimmers, Tracblocks, ovoids, wear knots and any other components that may rub or contact the borehole wall or formation material during a drilling operation.

The methods described herein are not limited to a particular type of drill bit, but may be utilized for any type of bit (with or without cutters). In addition to fixed cutter bits (e.g., PDC bits), other types of bits may be modeled, such as roller cone bits, hybrid bits, impregnated bits and any other type of bit that includes any surfaces that rub or otherwise contact the formation and/or borehole wall during a drilling operation.

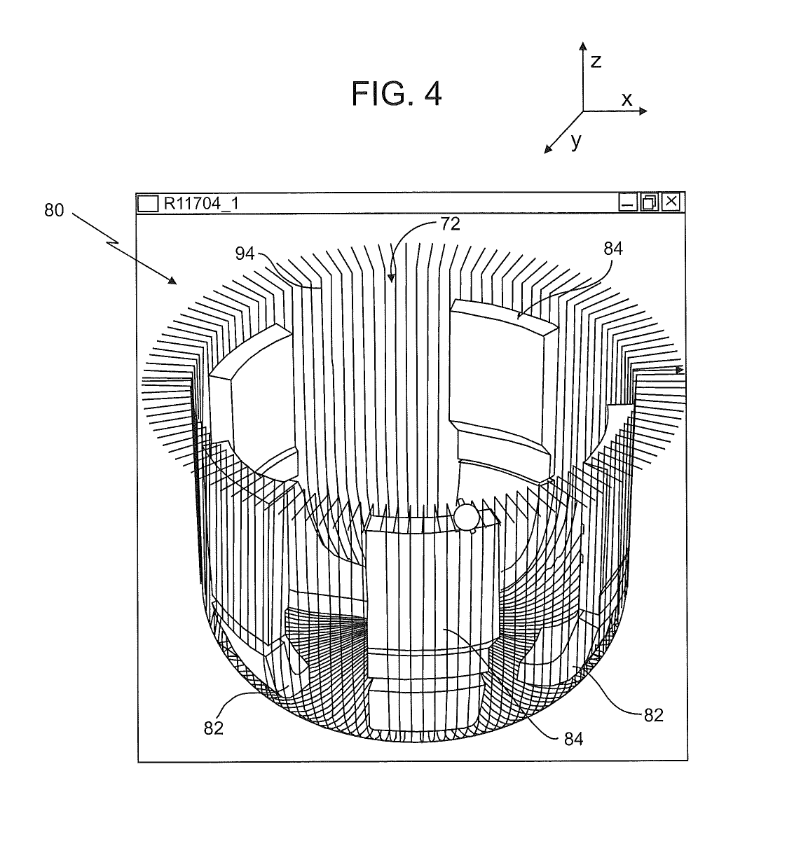

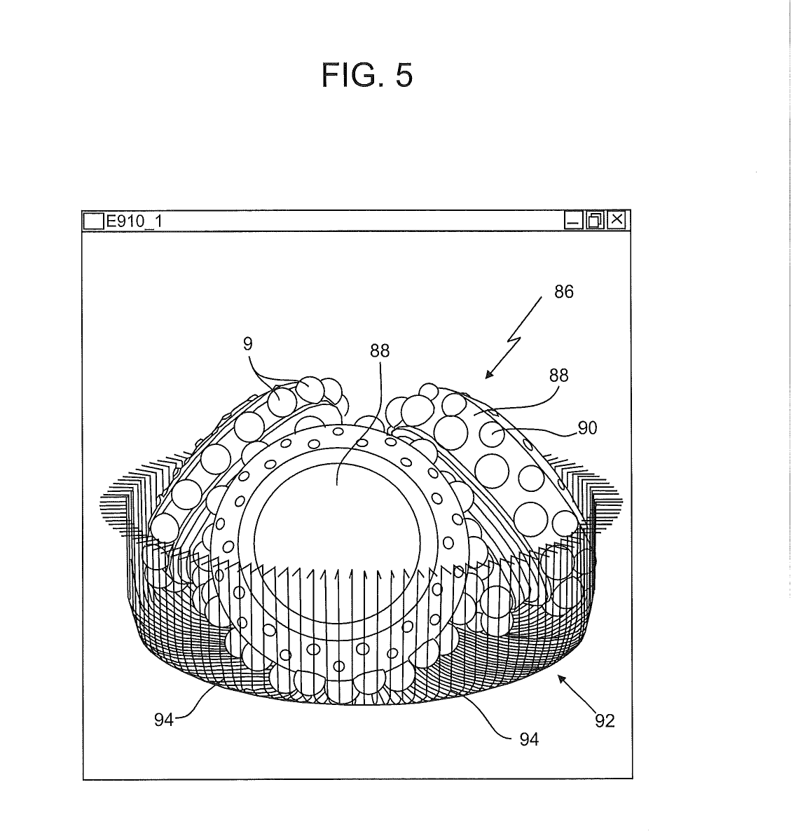

FIGS. 4 and 5 show exemplary geometric models of a drill bit. FIG. 5 shows a fixed cutter drill bit model 80, which includes three dimensional (3D) representations (also referred to as 3D objects) of various drill bit components. The model 80 includes, for example, 3D representations of blades and gage pads as blade objects 82 and gage pad objects 84. FIG. 5 shows a roller cone bit model 86 that includes 3D representations of roller cone shells and cutters as roller cone objects 88 and cutter objects 90. Any type of drill bit can be modeled in this way, including fixed cutter bits such as PDC bits and drag bits, various types of roller cone bits, and hybrid bits such as the Kymera™ drill bit by Baker Hughes, Inc, impregnated bits, and hybrid PDC-impregnated bits.

In one embodiment, the geometric model includes a 3D representation of the borehole surface geometry (referred to as a borehole model), which is used in conjunction with the geometric models of the drill bit in order to estimate various aspects of a drilling operation, e.g., contact forces and rock removal. Examples of a borehole model 92 are shown in drilling assembly models 80 and 86 of FIGS. 4 and 5.

In these examples, the rock surface beneath the drill bit is defined on a set radial spokes 94 in three dimensional space. This three dimensional space (referred to as the “borehole frame of reference” or “borehole frame”) can be represented by a Cartesian coordinate space having an X-axis, a Y-axis and a Z-axis, and also by a cylindrical coordinate space having the Z-axis and a radial R-axis. The Z-axis in the borehole frame is the initial axis the hole that will be drilled by the drill bit. The Z-axis is also the about which the spokes 94 are arrayed. Along each of these spokes 94 is a string of ordered nodes, each having a unique value of radial position and depth. As the bit drills through the rock during simulation, new nodes are added to the ordered string and these added nodes represent the new rock surface. In one embodiment, the average spacing between adjacent nodes is kept more or less constant to preserve the information content represented in the bottom-hole surface of the borehole model 92. The rock surface beneath the bit can be arbitrarily complex and may depend upon the dynamic trajectory history of the bit in the hole.

FIGS. 4-10 illustrate exemplary embodiments of models of individual components that can be incorporated into a drilling assembly model (e.g., the drill bit model 80, 86). Each component is represented individually by a 3D object. In one embodiment, each component is also represented by one or more corresponding two dimensional (2D) polygons corresponding to the 3D object. Each polygon described herein is represented by a number of nodes determined by the degree of resolution required for the corresponding 3D object.

For example, the roller cone bit shown in FIG. 5 includes roller cone objects 88 and cutter objects 90. Each roller cone shell represented by a roller cone object 88 is a rotating structure deployed on a bit frame. To a good approximation, each roller cone object 88 can be considered to form a surface of revolution, and thus the geometry of the cone shells can be shown as a surface of revolution when the drill bit is rotated.

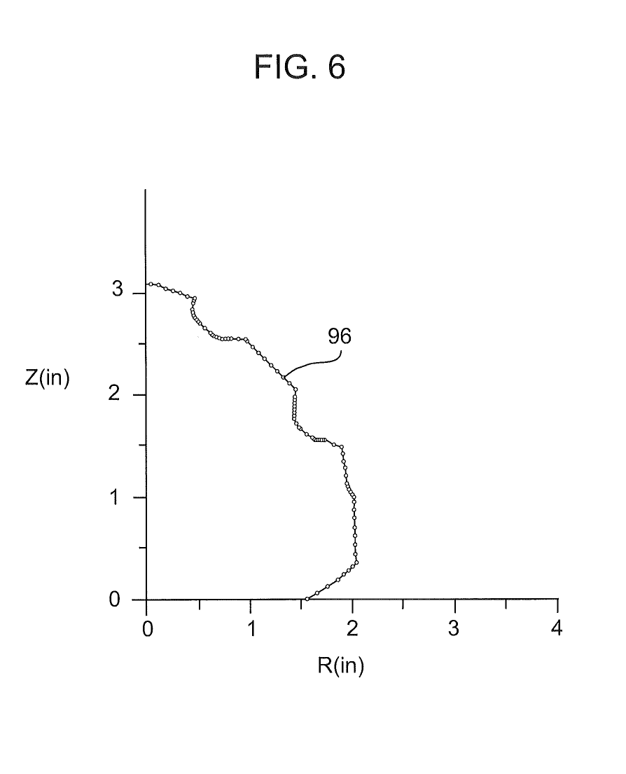

FIG. 6 shows a 2D polygon (roller cone shell polygon 96) that represents the surface of revolution of a roller cone object 88. The cone shell polygon 96 is represented in a cylindrical coordinate system having a Z-axis corresponding to the rotational axis of the drill bit and an R-axis corresponding to a radial distance from the Z-axis. When rotated about the Z-axis, the polygon represents the entire surface of revolution of the roller cone object 88.

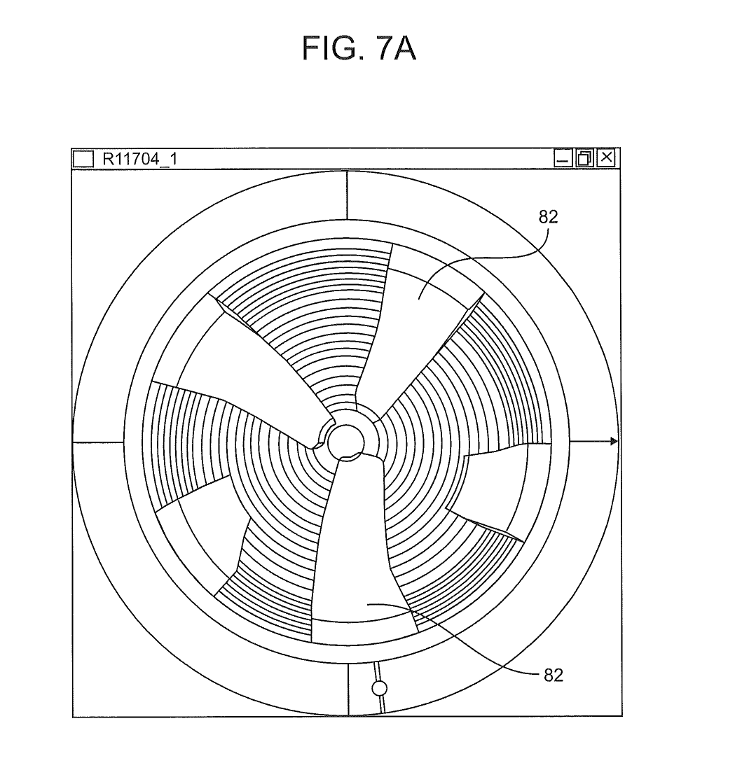

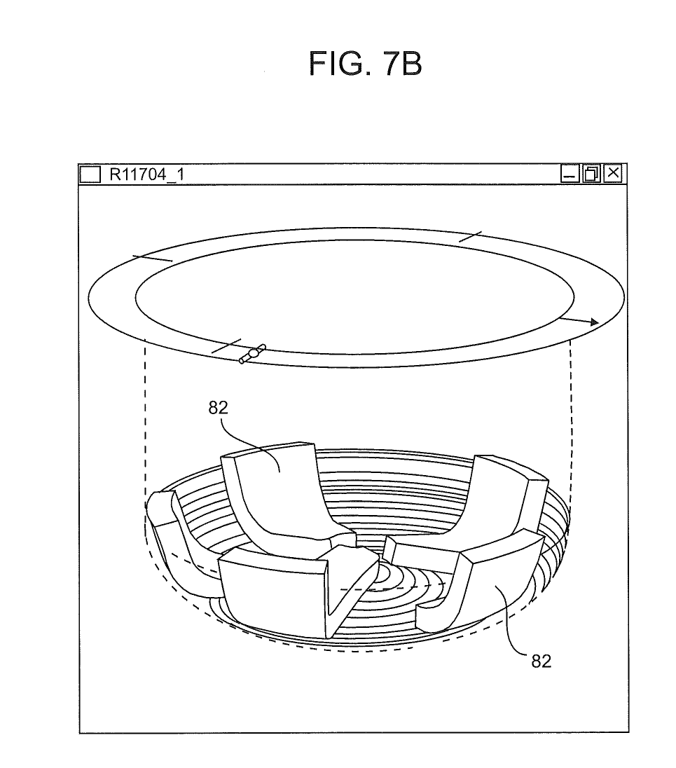

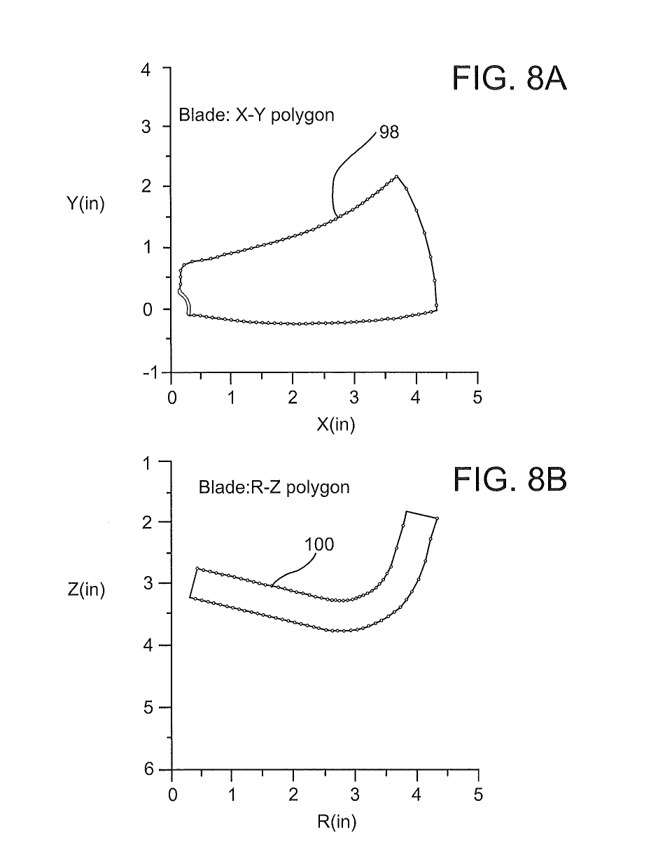

FIGS. 7A-7B and 8A-8B show a model of blade components of a fixed cutter bit such as a polycrystalline diamond compact (PDC) bit. FIG. 7 shows a 3D geometry of drill bit blades as blade objects 82, and FIG. 8 shows polygons (blade polygons 98 and 100) that are used to represent each blade object geometry. The polygons 98 and 100 may be used to totally govern the location and geometry of the corresponding blade object 82. In this example, a first blade polygon 98 is in a Cartesian frame of reference, and a second blade polygon 100 is in a cylindrical frame. The Z-axis in each frame is along the axis of rotation of the bit, and a plane perpendicular to the Z-axis is defined by the X and Y-axes. The R-axis represents the radial distance from the axis of rotation, where R=SQRT(X²+Y²). The blade polygons 98 and 100 define projections of the blade object 82 onto the X-Y plane and Z-R plane, respectively.

In this embodiment, description of each blade as a pair of polygons 98 and 100 forces the blade object 82 to be a subset of a surface of revolution about the rotational axis of the bit. The blade polygons 98 and 100 can be arbitrary (concave, convex) and can each thus be a simple polygon having any desired shape. Blade geometry can be different for different blades on the same bit.

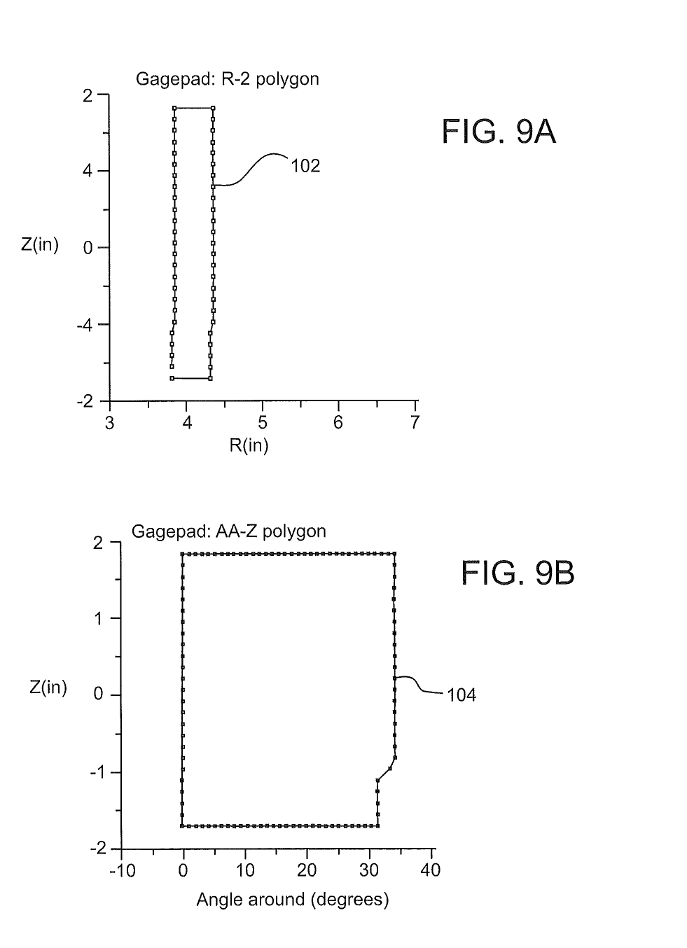

FIGS. 4 and 9A-9B show exemplary models of gage pads, which may be present on various types of bits, such as fixed blade bits, roller cone bits, impregnated bits, and hybrid bids. FIG. 4 shows the 3D structures of gage pad objects 84, which may be constructed in an analogous fashion as the blade objects 82. Each gage pad object 84 is represented by two polygons, i.e., gage pad polygons 102 and 104. The first gage pad polygon 102 is defined in the cylindrical frame of reference within the Z-R plane. The second gage pad polygon 104 is defined in an “angle around” (AA) frame, including a Z-axis along the axis of rotation and an AA-axis. “Angle around”, in this embodiment, is defined as, looking down on the X-Y plane (perpendicular to the Z-axis), that angle reckoned counter-clockwise with respect to the positive X-axis.

Again, the gage pad objects 84 are defined in this embodiment as subsets of surfaces of revolution about the axis of rotation of the bit. And as before, the gage pad polygons 102 and 104 can be simple polygons having any desired shape. For example, with this generality, both spiral and/or recessed gage pads can be represented. Gage pad geometry can be different from pad to pad on the same bit.

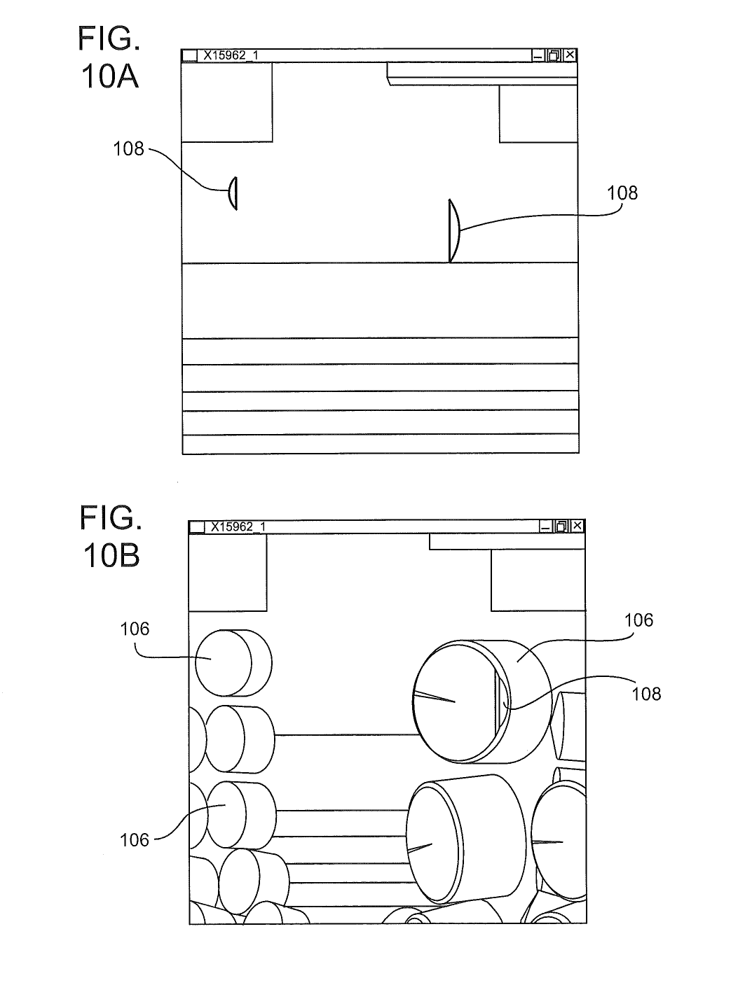

FIGS. 10A-10B show another drilling assembly component that can modeled as one or more 3D objects and associated 2D polygon(s). Gage cutters are represented as gage cutter objects 106, one or more of which include a ground flat or “mini-gage pad”. Each ground flat is represented by a ground flat object 108. Ground flats on gage cutters are created by grinding cutters located on the gage to a prescribed outside diameters. Each ground flat object 108 can be defined with the context of gage pads using the R-Z frame and AA-Z frame polygon approach discussed above. Wear flats on other cutters can be modeled in a similar manner. Cutters are placed on a bit as usual, and an arbitrary chosen profile is revolved about the vertical Z axis. The surfaces where this revolve intersects the cutting elements become the wear flats of the cutters.

The intersection of a cylindrical cutter located on the bit gage with a cylinder whose axis of symmetry is the bit axis and whose radius is the bit radius is determined. From this intersection, a polygon in the AA-Z plane can be created. A polygon in the R-Z polygon can be constructed from the vertical (Z) limits of the AA-Z polygon.

Other structures associated with the cutter may also be represented by the model. For example, the cutter body 55 associated with each cutter 54 shown in FIG. 2 may also be represented as a 3D object comprised of two more 2D polygons. This representation allows interactions (e.g., rubbing and/or crushing) to be simulated or predicted via the methods described herein.

The geometric models described herein, including the 3D objects representing drill bit components and the borehole, can be generated by any suitable method or algorithm. For example, the 3D objects are generated using the finite element method. In one embodiment, a plurality of node elements are generated from the geometric data that correspond to the shape or geometry of different components of the drilling assembly and/or the borehole. In one embodiment, the model includes (e.g., as model elements) any components of the drilling assembly (including crown components and body components) that rub against the borehole wall or casing, or otherwise come into contact with formation material. Nodes may also be included for the drill string portion, the mud motor 28 and optionally one or more reamers 30.

In the second stage 72 (referring again to FIG. 3), the above representations, including various 3D objects and model(s) of the borehole, are used to calculate portions of each drilling assembly component that contact the borehole. Various methods may be used to determine the interaction of the 3D rock surface with the 3D object. This method can be performed independent of the technique(s) used to construct the 3D objects.

In one embodiment, determining which drill bit surfaces or portions contact or interact with the formation includes determining whether nodes defining the borehole (e.g., nodes located along spokes 94) fall within an area defined by the 2D polygon(s) associated with a respective 3D object. This determination is made individually for each component. In one embodiment, for objects defined by multiple polygons, a borehole node is determined to have contact with a 3D object when the node is determined to fall inside each polygon area. This determination may be performed by any suitable algorithm, including fast algorithms for determining whether (in two dimensions) a point falls inside or outside a polygon. Areas of contact between modeled components and the borehole are thus obtained. The areas of contact are referred to as “rubbing surfaces” which denote any surface of the drill bit that contacts the borehole or formation during drilling.

The geometric model and contact calculations may be used to generate model(s) of contact forces, as well as models of rock removal by the components during drilling. The contact force and rock removal models are independent of the method employed to characterize the 3D rubbing surfaces.

In the third stage 73, contact forces on the rubbing surfaces (areas of an object that contact the borehole) are calculated. These contact forces may be calculated individually for each modeled drill bit component. Contact force, in one embodiment, is calculated based on contact stress and the surface area of a rubbing surface (referred to as a “contact area”).

In one embodiment, contact stress is calculated based on depth of penetration of a rubbing surface into a formation. For example, contact stress is a function of depth of penetration of the rubbing surface into the formation, which can be represented by the following relationships:

$$\begin{matrix}{σ}_{contact} = f ( δ , k ) , δ < {δ}_{crush} \\ = {σ}_{crit} , δ > {δ}_{crush}\end{matrix}$$

where “δ” is the penetration depth, k is the rock stifthess that will depend upon rock properties, “δ_{crush}” is the penetration depth at which a rock crushes, “σ_{crit}” is the critical stress at which rock crushes. The stress at which the rock crushes (σ_{crit}) will depend on the rock being drilled, the depth at which it is being drilled and the confining pressure (due to conditions such as depth, mud weight, etc.).

Parameters including δ_{crush} and δ_{crit} are input into the contact stress calculation from previously known information regarding the rock type and drilling conditions. For example, such parameters may be estimated based on downhole drilling operations or surface (e.g., laboratory) drilling tests.

In one embodiment, contact force at a given rubbing surface is calculated by multiplying the contact stress with the contact area calculated in stage 72. The direction of the contact force for a rubbing surface is normal to the local rubbing surface. Frictional forces may be characterized by multiplying a friction coefficient with the contact force, and the direction of the frictional forces is opposite the direction of motion of the rubbing surface with respect to the rock surface. The net force (on an element of the rubbing surfaces) is the vector sum of the normal force and the frictional force. This contact force and net force calculation is applied on a node by node basis across the surface of the rubbing body in contact with the rock.

Although the embodiments described herein include determining the intersection between 2D polygons and a borehole surface, they are not so limited. Any method or algorithm for determining an intersection between a component object and a borehole surface may be used. Any type of mathematical representation of the drilling assembly components and/or the borehole may be generated to determine an intersection between the borehole and surfaces of components. For example, the component(s) and/or the borehole surface may be represented by a polygon mesh, which may include many 2D polygons (i.e., greater than two) forming a 3D object. In one embodiment, the components are represented by polygon meshes and the borehole surface is represented by discrete elements (e.g., nodes). In another embodiment, both the components and the borehole surface are represented by polygon meshes, and intersection to determine contact area and force are calculated as mesh-mesh interaction between the components and the formation. In the fourth stage 74, an estimation or model of rock removal is generated. Rock may be removed by various mechanisms. For example, where contact stress σ_{contact} exceeds crushing stress σ_{crit}, the amount or volume of rock removed rock at least approximately equals the volume of rock displaced. The volume of rock displaced by a rubbing surface is calculated, for example, by multiplying the penetration depth δ by the contact area of the rubbing surface. For this case, at rubbing surface locations where rock is removed, the borehole node position at these locations is moved to the rubbing surface of the rubbing object.

Rock can also be removed by sliding wear, e.g., when contact stress σ_{contact} is less than crushing stress σ_{crit}. For this case, the rock node is moved a distance A from its initial position an in a direction normal and outward to the local rubbing surface. This distance can be represented by the following:

Δ=dL×f(σ_{contact},H,Aᵢ),

where dL is the incremental distance slid, H is the rock hardness and Ai (i=1-N) are calibration coefficients. One measure of rock hardness can be, but not limited to, either the confined or unconfined compressive strength of the rock. Incremental distance slid (dL) is the local (at position of rock node) velocity of the rubbing object relative to the rock node multiplied by “dt,” the incremental time while that node is in contact with the rubbing surface. The calibration coefficients may be determined by fitting the model to results from specifically designed laboratory experiments. The amount or volume of rock removed due to sliding wear can be calculated by multiplying the contact area by distance Δ.

Sliding wear can be calculated for any surface that rubs against the borehole. For example, for fixed blade bits such as PDC bits, such surfaces include rubbing surfaces associated with the cutters (e.g., cutter rubbing surfaces in shaped cutters) include any rubbing or sliding on the face of the cutter as well as rubbing on the cutter body, in the PDC part or in the backing.

Rubbing or sliding on the face of the cutter would be significant any time the cutter face is so oriented with respect to the formation that it does not cut the rock but rubs against it and possibly wears it down, in a similar fashion to what is described for rubbing surfaces. One example is a cutter on the gage that in certain positions has its face roughly parallel to the borehole surface. Thus, sliding wear can be calculated for any element typically considered to be a cutting element (including cutters and inserts) that is being operated in a mode where they would not cut but rub against the formation.

Rubbing on the body of the cutter can be included on, e.g., a PDC bit or on the backing part. This rubbing contribution could exist for any type of cutter, depending on its location, position/orientation, depth of cut and borehole topography.

In one embodiment, contact force is calculated not only for surfaces that contact an intact borehole surface, but also for instances where a surface contacts a borehole surface that includes crushed or worn rock. A surface exerts an axial force on this crushed rock (or any other formation material that has been modified by the drilling action) and adds another force component that is proportional to elastic and inelastic properties of the rock.

In one embodiment, the model includes an additional force component due to surfaces (e.g., block, ovoids) rubbing or sliding on formation material that has been already modified by the drilling assembly, e.g., crushed or worn rock particles due to blade contact. An axial force exerted in a direction normal to the rubbing surface can be included for the rubbing surface. This force can be represented as:

Additional force(WOB)=f(δ,k),

where δ is the penetration depth of the surface and k is the effective rock stiffness of the crushed/worn particles. This model can be applied for any components that may contact crushed or worn rock, such as structures located behind the cutters and/or shaped cutters that have both cutting and rubbing surfaces.

The rock removal models are not limited to those described herein, as any suitable model or calculation method can be used to estimate locations and amounts of rock removal based upon the modeled drilling assembly and contact conditions.

All of the information from the various models and model elements described herein can be combined into a drill bit dynamic motion model that includes dynamic motion and/or static parameters. As used herein, “dynamic motion” relates to a change in steady-state motion of the drill string. Dynamic motion can include vibrations and resonances. The term “static parameter” relates to a parameter associated with a drill string. The static parameter is generally a physical condition experienced by the drill string. Non-limiting examples of the static parameter include a displacement, a force or load, a moment (e.g., torque or bending moment), or a pressure.

Various parameters, such as drilling operation parameters and environmental parameters, may be input into the model and used to calculate, e.g., the depth of penetration and/or distance slid of component models and/or contact surfaces. Examples of such parameters include drilling fluid type, borehole temperature and pressure, and drilling parameters such as weight on bit (WOB), torque on bit (TOB), rotational rate (e.g., RPM) and steering direction.

In the fifth stage 75, various features and settings input into the model may be changed to simulate different drilling conditions and operations. For example, formation lithology can be changed to determine differences in rock removal rates and in contact forces on drill but components, so that removal and component wear can be measured for different simulated conditions. In addition, the design of various drill bit components can also be changed, such as the material used to construct the components and the geometric design of components. These can be run in the model to affect design changes to the drill bit and/or drilling/steering parameters.

In addition, the models described herein can be used to estimate various behaviors of the drilling assembly as a function of input forces such as weight-on-bit, drilling rotation speed, fluid pressure, mass imbalance forces, axial stresses, radial stresses, weights of various components, and structural parameters such as stiffness. Various dynamic behaviors can be predicted, such as axial events (e.g., bit bounce, Kelly bounce), lateral events, torsional events and whirl events. Other behaviors include predictions of changes in the borehole (e.g., diameter, azimuth and inclination), as well as changes in borehole quality (e.g., spiraling, over gauge). The prediction may include outputs such as new azimuth and inclination, build rate and others. Other behaviors include, but are not limited to, build-up rate, bit and BHA stability with regards to lateral vibrations, torsional oscillations and stick-slip, bit walk, hole spiraling and hole quality.

An exemplary method or algorithm for calculating interactions between components (via the 3D models of each component) is described below. This algorithm may be used to calculate rubbing surfaces, i.e., surfaces that come into contact with the borehole or formation during drilling. The procedure is outlined below in pseudo-code. Note that there can be multiple distinct areas of contact on the rubbing surface with the rock. This example is not meant to be limiting, as any suitable algorithm may be used to calculate contact or interaction between the 3D models and a formation or borehole surface.

In this example, the algorithm is performed as a time-step procedure, i.e., is repeated for a number of time points (time step N) within a selected time window. The following is performed for each rubbing object on the drill bit. At a first time step N:

1. A set of locations on the borehole surface is selected. In this example, a pair of spokes 94 is selected. A 3D rubbing surface might cross the origin (X=Y=0) of the spoke system (or Z=R=0 in cylindrical space) in the rock frame of references. In order to avoid issues with this, a spoke (the “primary spoke”) and its mirror spoke located 180 degrees away from the primary spoke (the “complimentary spoke”) are merged into one continuous string of nodes (also referred to as a “spoke pair”).
2. Each node along a selected spoke pair is analyzed to determine whether the node contacts the rubbing surface or otherwise contributes to the contact area. The following analysis is performed on each node as the algorithm steps along the merged spoke pair on a node by node basis:
3. The node is transformed from the borehole frame of reference into the bit frame of reference (e.g., an orthogonal or cylindrical frame of reference having a Z-axis along the drill bit's rotational axis). In general, the drill bit will have an arbitrary orientation and location within the hole. For the algorithms to be applied, the position of the rock node is defined in the bit frame of reference so that a determination can be made as to whether the node is located within the component model area.
4. A test is applied to determine whether the node is inside or outside the 2D polygon(s) associated with a model of a drill bit component (e.g., a 3D component object). Various algorithms may be used to determine when a point is inside or outside of a closed polygon. An exemplary algorithm is described in M. E. Mortenson, Mathematics for Computer Graphics Applications, 2^{nd} Edition, Industrial Press, Inc., 200 Madison Avenue, New York, N.Y., 1999, pp. 202-204. For example, for models of blades, gage pads and grind flats, this test is applied to two polygons. The node is deemed to be “inside” the 3D object if the node is determined to be inside both of the polygons. If the node is outside one of the polygons, it is deemed to be “outside” of the 3D object.
5. If a previous node along the spoke pair has been analyzed (i.e., determined to be inside or outside the object), the algorithm proceeds to step 6. If the present node is the first node on the spoke pair to be analyzed, then the algorithm returns to step 2 to analyze the following node. As described in this example, a node “before” or “preceding” a selected node is a node adjacent to the selected node on the spoke pair that occurs before the selected node in the order that the nodes are analyzed. Likewise, a node “following” or “after” a selected node is an adjacent node that occurs after the selected node in the order of analysis.
6. If the present node is inside the 3D object, but the preceding node was outside the object, a line segment between the present node and the preceding node is calculated, and the intersection of the line with the polygon(s), i.e., the “entry point”, is calculated. For example, a line segment between the present node (occurring just after entry) and the preceding node (occurring just before entry) is intersected with the polygon. In one embodiment, for objects including blades, gage pads and ground gage flats represented by two polygons, this is a simple 2D linear intersection. For the case of a roller cone shell object, the intersection solution is non-linear.
7. If the present node is outside the 3D object, but the preceding node was inside the object, a line segment between the present node and the preceding node is calculated, and the intersection of the line with the polygon(s), i.e., the “exit point”, is calculated. The line segment thus extends between the node occurring just before exit from the object and just after exit. It is noted that multiple entry and exit points along a spoke pair for a given 3D object may be detected. If the spoke pair includes additional nodes that have not been analyzed for the present spoke pair, the algorithm returns to step 2. Otherwise, the algorithm continues to step 7.
8. The contact area is calculated based on the nodes determined to be inside of the object and each exit and entry point calculated relative to the object. In one embodiment, the contact area is calculated by multiplying the length of the spoke pair that is in contact by the distance between the spoke pair and an adjacent spoke pair. For example, the length along a spoke pair is calculated by stepping along the spoke pair, and accumulating the sum of that stepping length between an entry point and an exit point and all nodes in between. A surface distance “coordinate” (“as the ant crawls”) may be developed to facilitate calculating the contact area.
9. The contact forces on the calculated contact areas (e.g., due to rubbing surfaces) are calculated.
10. The contact forces are then applied via the model to the drill bit. In one embodiment, the forces are applied to the bit in the rock frame of reference. Therefore, the forces are transformed back to the rock frame of reference.
11. The net forces on the bit (i.e., on the rubbing surfaces calculated along the present spoke pair) are accumulated.
12. Rock removal by the rubbing surfaces is calculated. For example, the amount of rock removed from a rubbing surface includes the amount of rick displaced as well as the sliding wear as described above.
13. Steps 1-12 are repeated for each rubbing surface.
14. Steps 1-13 are repeated for each time step.

The methods and algorithms described herein have a variety of applications, including simulation of drilling under various conditions and in various types of rock or other formation materials.

Various input parameters may be modified as necessary to change the design of the drill string (e.g., the drill bit, BHA and/or other drill string components) so that the simulated behavior is within selected limits. Such design changes may include shape or diameter of the bit body or other components of the drilling assembly, modification or inclusion of stabilizing structures on the bit body or drill string portion. Other design changes may include changing the weight, diameter, thickness and/or stiffness of tubular elements, and changing the side and/or front exposure of the cutters. Other parameters that can be changed include operating parameters such as rotational speed and weight on bit. After these parameters are changed, the behavior is again simulated to determine whether improvement and/or stability increase. Such design changes can be performed on the model and the model simulated in an iterative fashion to optimize the design of the drill string and/or the operating parameters.

In addition, rock properties (e.g., strength, porosity and others) can be modified to model various scenarios when the true rock properties are not well defined. Design changes could include adding new elements and/or changing one or several aspects of existing elements, such as geometric features, numbers of parts in the element, material, polishing and surfacing/coating and others. Any of these can be modified to determine a potential effect on how the system responds while rubbing. Another parameter that could be changed is mud weight—this would affect the effective hardness of some rocks and modify the drilling response.

For example, the models described herein can be used to design drill bits and/or operational parameters to control exposure of various components during different phases of drilling operations, and/or control wear on such components.

The systems and methods described herein provide various advantages over prior art techniques. For example, models of the drilling assembly can be generated and tested that include a complete description of the drilling forces and rock removal during drilling operations. In addition, models can be generated that include individually calibrated models of each component to provide a more accurate picture of drilling behavior. Applications of the systems and method described herein include optimization of drill bit component geometries for directional drilling applications, optimization of rubbing surfaces (reduced exposure surfaces) for directional drilling applications, and optimization of cone shell design geometry to minimize bit tendency for off-center drilling for roller cone bits.

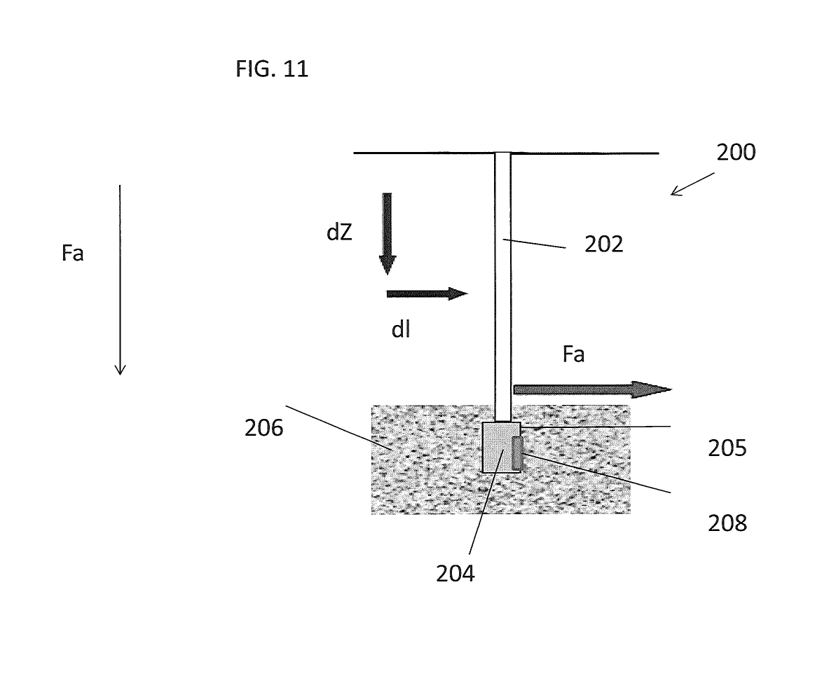

As generally described above, the models just described can be utilized to simulate additional operational characteristics of a drill bit either as designed or as part of a design process. FIG. 11 shows a simplified example of a system 200 for which simulation according to the above disclosure could be implemented. In this system 200, a drill pipe 202 has a side load Fs and an axial load Fa applied to it. These loads cause the side 205 of the drill bit 204 opposite the side load Fs to contact the rock 206. In particular, the gage pad 208 on the side labeled as 205 contacts the rock 206. Of course, the bit 204 can have gage pads disposed all about it as shown above. As is known in the art, the application of a side load Fs will cause the bit to travel in a lateral direction (represented by arrow dL) as it also travels in the axial direction (represented by arrow dZ).

In one embodiment, the values of lateral displacement (dL) at each depth (dZ) can be stored during the simulation. The parameter dL/dZ is the slope of the lateral displacement vs. drilling depth curve and reflects how much the bit drills laterally with increasing depth. Such information could be used, for example, to select a particular drill bit design based on expected actual side load conditions.

Bit dynamic stability in a drilling context refers to lateral vibration typically manifested in backward whirl. Depth limiting features such as wear knots or ovoids can improve the stability of a bit, but only at the expense of drilling efficiency. The standard laboratory protocol for stability testing is, under ROP control, to ramp up ROP in steps from 3 ft/hr to 96 ft/hr on the surface rig and evaluate when the bit stabilizes. At low ROP's, PDC bits are typically unstable and ultimately stabilize with increasing ROP. The stability protocol requires tests to be done in either Carthage or Bedford limestone. The laboratory determination of when the bit stabilizes is by means of continuously tracking the lateral trajectory of the pipe 202 just above the bit using laser ranging devices and, from that data, determining when the bit begins on-center smooth drilling. Note that no side load is applied to the bit in these prior art dynamic stability tests.

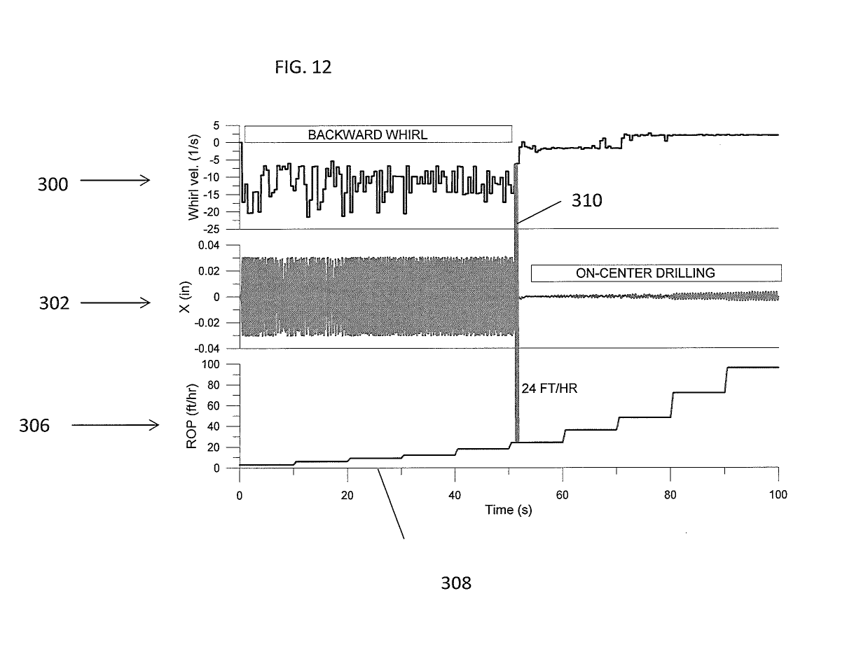

FIG. 12 includes three graphs 300, 302, 304 all of which have a time axis 306 measured in seconds. These graphs, respectively, show whirl velocity, an excursion for the bit away from its axis of rotation, and stepwise increases in the ROP related to a single simulation plotted along a time axis. Before ROP reaches 24 ft/hr (as indicated by line 310), the bit exhibits instability due to both backward whirl (graph 300) and off center drilling (graph 302). After that time, the bit stabilizes.

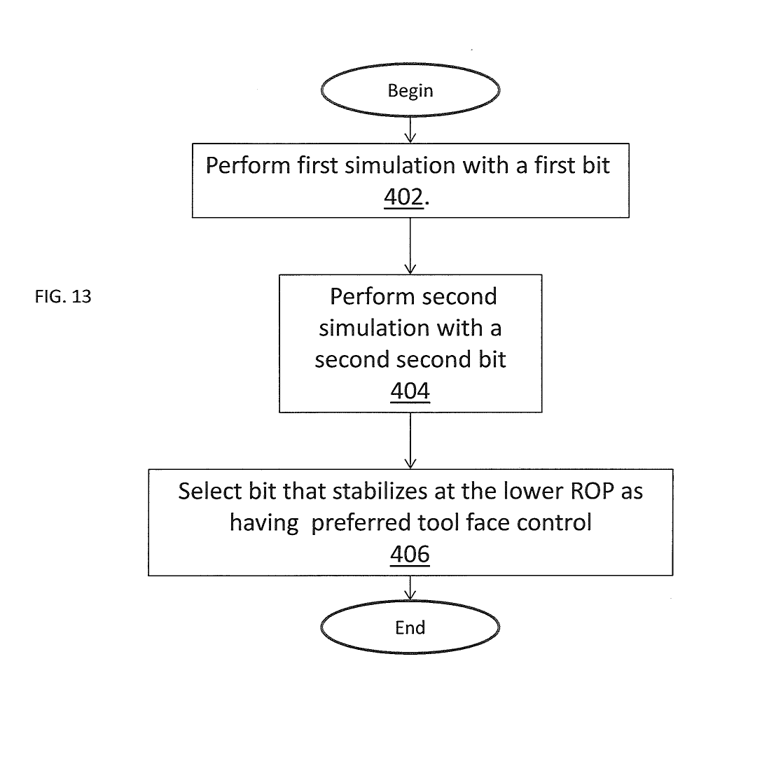

FIG. 13 shows a method according to one embodiment. In this embodiment, a simulation of a bit drilling is performed for a first bit at block 402. At block 404 a second simulation is performed for a second bit. At block 406, the bit that stabilizes at the lower ROP is determined to be the “better” bit for tool face control. It shall be understood, that the first bit could be a standard bit and selection of it could mean that the second bit is not selected for use in directional drilling because of its less than desired tool face control. According to one embodiment, the simulations are performed without a side load being applied because it has been discovered, as explained further below, that application of a side load may make a bit appear to exhibit better tool face control in a simulation than in practice.

While the above selection process is relatively simple, the actual understanding is based on consideration of other factors that can be provided by the above described simulations. For example, one hypothesis was that a less aggressive cutting structure was needed in order to mitigate tool face fluctuations (e.g., to improve tool face control). To test this hypothesis, two bits were designed such that the profiles were different (Profile A and Profile B), but backrake and chamfer were the same on both bits. The radial location of each cutter was also kept as constant as possible. A series of simulations were then performed according to the above described methods to compare the designs to one another. The first set of simulations consisted of the following conditions: the ROP was ramped from 0 to 48 ft./hr. continuously; a side load of 2000 lbs. was applied to mimic the side force caused by the motor with the bent AKO; the rock strength was set to 12,000 psi; and cutters and gauge pads were included in the model. WOB, torque, axial and lateral displacement with respect to time and other variables were recorded.

It was discovered that side loads often help stabilize bits. As a result, the both designs drilled stably throughout the simulation.

In a different simulation, no side load was applied. That test indicated showed disparities in when whirl ceased (e.g., when the bit became stable). Further, field testing has indicated that the bit that became stable at the lower ROP showed better tool face control. In short, side load was found to mask instability and, as such, in one embodiment, the simulations disclosed herein are performed without addition of a side load.

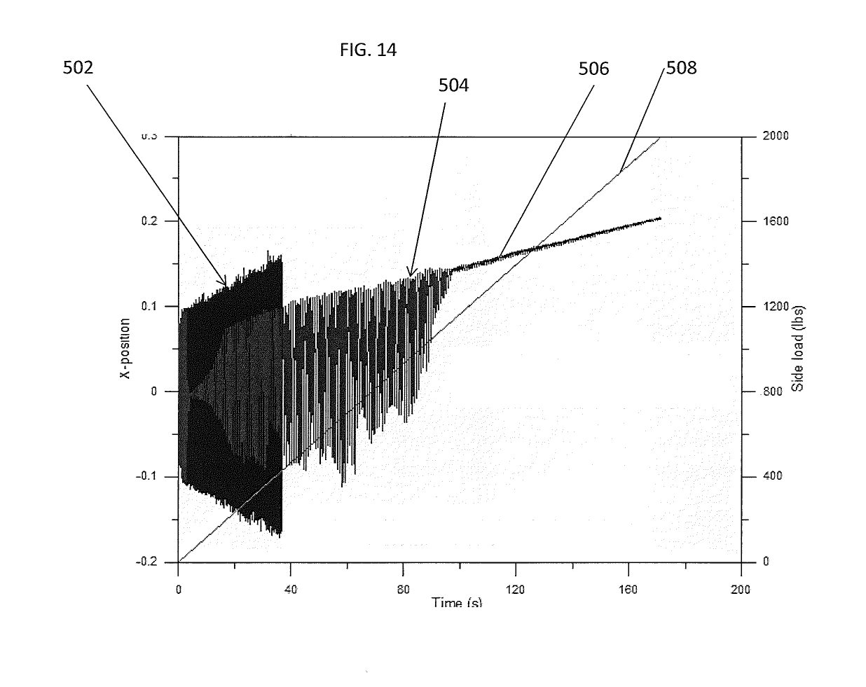

FIG. 14 illustrates the lateral displacement from a center point of bit (e.g. whirl) over time as a side load is increased. In FIG. 14, the rate of side load increase is indicated by line 508. The offset of the first bit (shown by trace 502) indicates that even with increasing side load, the lateral displacement continued to increase. It shall be understood that while not providing useful stability information, the trace 502 can be used to interpret hole size increase due to an unstable bit. In particular, the displacement in each direction can be added to the size of the bit to determine the size of the hole created by the particular bit if operated in an unstable state. Further, and with reference to both FIGS. 12 and 14, the graphs therein can be used to set a side load and ROP below which the bit will whirl while still having a lateral travel component. Such operation will result in a laterally traveling borehole that has a desired increased size (at least in a particular region) relative to the size of borehole created during stable operation.

FIG. 14 further includes a second trace 504 that describes a bit that is initially unstable and then reaches a stable laterally travelling orientation when the side load exceeds about 1100 lbs as indicated by region 506. In this region the bit operates stably and has a lateral component to it direction.

As discussed above, formation material removal model can be generated individually for each portion of the bit. In more detail, the models represent the geometry of the drill bit and simulate or predict the drill bit's interaction with the formation during drilling, including the forces exerted on individual components of the drill bit that contact the formation. The model can be used, for example, by a drill ahead model or a build-up rate predictor. In such cases, the prediction of the bit behavior can be used in combination with a BHA model to predict the trajectory of the BHA in two or three dimensions. Thus, the directional response of the drill bit can include effects of the BHA in one embodiment. Embodiments herein can take advantage of previously measured or simulated data for use in calibrating the material (rock) removal model as it relates to the bit body. In particular, in one embodiment, for a given rock type and drilling fluid type, numerical bit/drill string actual tests (e.g., “lab tests”) where various combinations of axial and lateral loading are conducted. The results of the simulations and tests produce outputs that include one or both of a drilling trajectory and drilling velocity as well as possible other values. According to one embodiment, the axial and lateral displacements from both the simulation and the tests can then be compared to calibrate the rock removal model. In one embodiment, the inputs for the simulation and the actual test are substantially identical. For example, in both the simulation and the actual test axial WOB and side load are set to the same values.

After calibration as described above, it shall be understood that the model can be used to run simulations with different bits to match certain conditions and desired directional properties. These simulations can be formation specific, depth specific, gage pad geometry specific, side load magnitude specific simulate as well as to specific operating parameters such as RPM, ROP, and WOB or any combination thereon. Further, it shall be understood that any of the above factors can be varied not only to determine the directional drilling characteristics of the bit but also its dynamic stability.

Generally, some of the teachings herein are reduced to an algorithm that is stored on machine-readable media. The algorithm is implemented by the computer processing system and provides operators with desired output.

In support of the teachings herein, various analysis components may be used, including digital and/or analog systems. The digital and/or analog systems may be included, for example, in the processing unit 36. The systems may include components such as a processor, analog to digital converter, digital to analog converter, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, motive force (such as a translational force, propulsional force, or a rotational force), digital signal processor, analog signal processor, sensor, magnet, antenna, transmitter, receiver, transceiver, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The term “or” when used with a list of at least two items is intended to mean any item or combination of items.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of predicting behavior of a drill bit, comprising:
generating, by a processor, a representation of at least one component of the drill bit, the representation representing a three-dimensional object;
representing a borehole formed in an earth formation during a drilling operation by generating a mathematical representation of a borehole surface defined by a plurality of nodes;
simulating operation of the drill bit within the borehole with the application of an axial load and a side load;
determining whether the three-dimensional object is in contact with the borehole surface by determining if one of the nodes is within both of the two-dimensional polygons during the simulation; and
estimating an amount of lateral motion of the drill bit during the simulation.

2. The method of claim 1, wherein the representation is a combination of at least two two-dimensional polygons

3. The method of claim 1, wherein the at least one component is a gage pad disposed on a body portion of the drill bit.

4. The method of claim 3, further comprising estimating formation material removal caused by contact between the gage pad and the formation.

5. The method of claim 1, wherein the borehole surface includes:
a plurality of spokes arrayed along the borehole surface and arranged about a central axis corresponding to an initial axis of rotation of the drill bit; and
a plurality of nodes arrayed along each of the plurality of spokes.

6. The method of claim 1, wherein the borehole surface includes a plurality of nodes arrayed thereon, and estimating contact includes determining whether one or more of the plurality of nodes falls within the three-dimensional object.

7. The method of claim 1, further comprising:
calibrating the simulation of the drill bit operation by comparing the estimated lateral motion to an actual lateral motion produced in a laboratory test operating under the same axial and side loads.

8. A method of selecting a drill bit for directional drilling, comprising:
generating, by a processor, a representation of at least one component of the drill bit, the representation representing a three-dimensional object as a combination of at least two two-dimensional polygons;
representing a borehole formed in an earth formation during a drilling operation by generating a mathematical representation of a borehole surface defined by a plurality of nodes;
simulating operation of the drill bit within the borehole with the application of a weight on bit (WOB) the simulation including causing the drill bit to initially rotate about a drill bit axis that is coaxial with an axis of the borehole, the simulation including increasing one of the WOB and a rate of penetration (ROP) of the drill bit over time; and
determining the WOB or ROP that results in the drill bit stabilizing in the borehole.

9. The method of claim 8, wherein the at least one component is a gage pad disposed on a body portion of the drill bit.

10. The method of claim 9, further comprising estimating formation material removal caused by contact between the gage pad and the formation.

11. The method of claim 8, wherein the borehole surface includes:
a plurality of spokes arrayed along the borehole surface and arranged about a central axis corresponding to an initial axis of rotation of the drill bit; and
a plurality of nodes arrayed along each of the plurality of spokes.

12. The method of claim 8, wherein the borehole surface includes a plurality of nodes arrayed thereon, and estimating contact includes determining whether one or more of the plurality of nodes falls within the three-dimensional object.

13. The method of claim 8, wherein determining includes determining the displacement of the drill bit axis from the initial axis of the borehole over time.

14. A method of selecting a drill bit for directional drilling, comprising:
generating, by a processor, a representation of at least one component of the drill bit, the representation representing a three-dimensional object;
representing a borehole formed in an earth formation during a drilling operation by generating a mathematical representation of a borehole surface defined by a plurality of nodes;
simulating operation of the drill bit within the borehole with the application of a weight on bit (WOB) and a side load, the simulation including causing the drill bit to initially rotate about a drill bit axis that is coaxial with an axis of the borehole, the simulation including increasing one of the WOB and a rate of penetration (ROP) of the drill bit over time; and
determining the WOB or ROP that results in the drill bit stabilizing in the borehole.

16. The method of claim 14, wherein determining includes determining the displacement of the drill bit axis from the initial axis of the borehole over time.

17. The method of claim 15, wherein the representation is a combination of at least two two-dimensional polygons.

18. A method of selecting between one of two drill bits for use in directional drilling, comprising:
generating, by a processor, a representation of at least one component of a first and a second drill bit;
representing a borehole formed in an earth formation during a drilling operation by generating a mathematical representation of a borehole surface defined by a plurality of nodes;
simulating operation of the first drill bit and the second drill within the borehole with the application of an axial load, the simulation including causing the first and second drill bits to initially rotate about a drill bit axis, the simulation including increasing the side load of the first and second drill bit over time;
determining the side load that results in the first and second drill bits stabilizing in the borehole; and
selecting from the first and second drill bit for direction drilling the one stabilizes at the lower side load.

19. The method of claim 18, wherein the representation is a combination of at least two two-dimensional polygons.
